(19) United States
(12) Patent Application Publication
(10) Pub. No.: US 2011/0008603 A1
(43) Pub. Date: Jan. 13, 2011

(54) POLYOLEFINIC HEAT SHRINKABLE FILM AND METHOD THEREOF

(75) Inventor: Thea Ellingson, Northfield, MN (US)

Correspondence Address: BARNES & THORNBURG LLP, 11 SOUTH MERIDIAN, INDIANAPOLIS, IN, 46204, US

(73) Assignee: BERRY PLASTICS CORPORATION, Evansville, IN (US)

(21) Appl. No.: 12/831,029

(22) Filed: Jul. 6, 2010

Related U.S. Application Data
(60) Provisional application No. 61/223,920, filed on Jul. 8, 2009.

(51) Int. Cl. B32B 5/00; C08L 23/06

(52) U.S. Cl. 428/220; 525/240

(57) ABSTRACT

A polyolefinic composition and film made thereof for heat shrinking goods is described. The polyolefinic composition and film made thereof comprises a blend of polyethylene that shrink in response to heat so as to contain a good. The heat shrinkable film may be placed over a good and subjected to heat so that the film shrinks causing the good to be subjected to a predetermined shrink tension with sufficient tensile and puncture properties to contain the good. Heat shrink polyolefinic films are used for applications where the goods to contain may be loosely assembled goods.

### PRIORITY CLAIM

This application claims priority under 35 U.S.C. §119(e) to U.S. Provisional Application Ser. No. 61/223,920, filed Jul. 8, 2009, which is expressly incorporated by reference herein.

### BACKGROUND

The present disclosure relates to a monolayer film and a polymeric composition for heat shrink packaging applications, and to a method of making the same. More particularly, the present disclosure relates to polyolefinic films useful as heat shrink packaging films and a process for making the same.

### SUMMARY

According to the present disclosure, a monolayer shrink film is described. The monolayer shrink film includes a blended composition of high-density polyethylene, low-density polyethylene, and metallocene polyethylene.

In illustrative embodiments, the composition is such that the film exhibits a shrink tension of greater than 3 psi as determined according to ASTM D-2838-00 at 280 degrees F. The film has properties that make it useful for shrink packaging; particularly, the film exhibits improved shrink tension, load retention, puncture resistance, tear resistance, and tensile strength. In illustrative embodiments, a film which exhibits significant shrinkage upon heating is described.

Additional features of the present disclosure will become apparent to those skilled in the art upon consideration of illustrative embodiments exemplifying the best mode of carrying out the disclosure as presently perceived.

### DETAILED DESCRIPTION

The present disclosure is related to a monolayer shrink film having a shrink tension greater than 3 psi as determined according to ASTM D-2838-00 at 280 degrees F. Reference is made to each ASTM standard test methods described herein, which ASTM standard test methods are hereby incorporated by reference herein, for disclosure relating to the methods for testing polymeric compositions and films made thereof.

Shrink films in accordance with the present disclosure have many beneficial attributes; for example, the combination of light gauge, high shrink tension, and final tensile properties allow for the efficient containment of goods. Furthermore, the monolayer structure enables the recycling of the manufacturing process by-products and of the post-consumer product. The blend of polymers used to make the film enables thinner films to be used in applications previously requiring the use of thicker films. This concept, known as down-gauging, saves material, expense, energy, and consequently down-gauging is environmentally friendly.

In accordance with embodiments of the present disclosure, the product and method described herein exhibits surprising improvements in key shrink film performance characteristics. Particularly, the disclosed composition exhibits improved shrink tension, machinability, puncture resistance, tear resistance, and tensile strength while maintaining the generally recognized advantages of shrink films.

As used herein, high density polyethylene (HDPE) is defined as a polyethylene having a density of between about 0.939 and about 0.960 g/cm³ and a melt index of between about 0.15 and about 1.0 g/10 minutes. In one embodiment of the present disclosure, the HDPE has a molecular weight distribution exhibiting a bimodal distribution. As used herein, the term bimodal distribution means that the molecular weight distribution in a gel permeation chromatography (GPC) curve or a distribution plot generated by a comparable analytical technique exhibits at least two populations of polymer molecules having distinct molecular weight distributions. These distinct molecular weight distributions may appear through analysis to appear as distinct peaks, one or more humps and one or more peaks, one or more shoulders on one or more peaks, or one or more tails relative to one or more peaks. Using the appropriate software, a molecular weight distribution plot of a bimodal polymer composition can be deconvoluted into two or more component peaks. For example, the deconvoluted peak with the lower average molecular weight could be described as a low molecular weight component and the other could be described as a high molecular weight component. After deconvolution, the peak width at half maxima and the weight average molecular weight (M_{w}) of each component can be described separately.

Accordingly, while the molecular weight of a HDPE may be characterized by an average molecular weight, the distribution may be more appropriately characterized by a first component having a first average molecular weight and a second component having a second average molecular weight. For example, HDPE with a bimodal distribution may include a first population of polyethylene having an average molecular weight distribution of about 30,000 g/mol and a second population of polyethylene having an average molecular weight distribution of about 400,000 g/mol. While the molecular weight distribution is bimodal, the density and melt index either of the two populations and/or the composition as a whole may fall within those ranges described herein as characteristic of HDPE. Reference may be made to U.S. Pat. No. 6,787,608 for examples of resins which may be particularly useful herein. The bimodal nature of the HDPE is an aspect that contributes to the blended composition providing its recognized properties (shrinking, strength, light scattering, etc.).

In illustrative embodiments, the film comprises HDPE having a melt index (MI) of about 0.15 to about 1.0 g/10 min. In one embodiment, the film comprises HDPE having a MI of about 0.3 to about 0.8 g/10 min. In one embodiment, the film comprises HDPE having a MI of about 0.5 g/10 min. In illustrative embodiments, the film comprises HDPE having a density of about 0.939 to about 0.960 g/cm³. In one embodiment, the film comprises HDPE having a density of about 0.945 to about 0.954 g/cm³. In another embodiment, the film comprises HDPE having a density of about 0.950 g/cm³.

In illustrative embodiments, the film comprises HDPE having a first population of polyethylene with an average molecular weight distribution of about 10,000 to about 60,000 g/mol. In one embodiment, the film comprises HDPE having a first population of polyethylene with an average molecular weight distribution of about 25,000 to about 45,000 g/mol. In another embodiment, the film comprises HDPE having a first population of polyethylene with an average molecular weight distribution of about 35,000 g/mol. In illustrative embodiments, the film comprises HDPE having a second population of polyethylene having an average molecular weight distribution of about 100,000 to about 600,000 g/mol. In one embodiment, the film comprises HDPE having a second population of polyethylene having an average molecular weight distribution of about 300,000 to about 500,000 g/mol. In another embodiment, the film comprises HDPE having a second population of polyethylene having an average molecular weight distribution of 375,000 to about 450,000 g/mol.

In illustrative embodiments, the film comprises HDPE having a M_{w}/Mₙ of less than about 20, wherein M_{w} is the weight average molecular weight and Mₙ is the number average molecular weight. In one embodiment, the film comprises HDPE having a M_{w}/Mₙ of about 10 to about 18. In another embodiment, the film comprises HDPE having M_{w}/Mₙ of about 5 to about 10.

As used herein, low density polyethylene (LDPE) is defined as a polyethylene having a density of between 0.915 and 0.930 g/cm³ and a melt index of between 0.3 and 1.0 g/10 minutes. In one aspect of the present disclosure, LDPE includes a high degree of short and long chain branching. In one aspect of the present disclosure, LDPE may not pack into the crystal structures well. Therefore, LDPE may have a tendency to form amorphous solid structures. Accordingly, the intermolecular forces are weaker and the instantaneous-dipole induced-dipole attraction may be lower. Furthermore, LDPE has a lower tensile strength than HDPE but comparably greater ductility. LDPE may be polymerized through free radical processes which account for the high degree of branching with long chains. The term LDPE is intended to include high pressure low density polyethylene (HPLDPE) polymerized through a high pressure free radical polymerization.

In illustrative embodiments, the film comprises LDPE having a MI of about 0.3 to about 1.0 g/10 min. In one embodiment, the film comprises LDPE having a MI of about 0.5 to about 0.8 g/10 min. In another embodiment, the film comprises LDPE having a MI of about 0.65 g/10 min. In illustrative embodiments, the film comprises LDPE having a density of about 0.915 to about 0.930 g/cm³. In one embodiment, the film comprises LDPE having a density of about 0.920 to about 0.925 g/cm³. In another embodiment, the film comprises LDPE having a density of about 0.92 g/cm³.

The term metallocene catalyzed polyethylene (mPE) is used to describe a copolymer of ethylene and an alpha olefin comonomer made through a metallocene single site catalyzed reaction. mPE also includes polymers made through non-metallocene or post-metallocene catalyzed reactions resulting in a copolymer of ethylene and an alpha olefin copolymer. mPE includes copolymers made with various alpha olefin monomers including 1-butene, 3-methyl-1-butene, 3-methyl-1-pentene, 1-hexene, 4-methyl-1-pentene, 3-methyl-1-hexene, 1-octene or 1-decene. The alpha olefin comonomer may be incorporated from about 1% to about 20% by weight of the total weight of the polymer, preferably from about 1% to about 10% by weight of the total weight of the polymer. Reference may be made to U.S. Pat. Nos. 3,645,992; 4,011,382; 4,205,021; 4,302,566; 6,184,170; and 6,919,467 and U.S. Publication Nos. 2008/0039606 and 2008/0045663 for examples of resins which may be particularly useful herein.

In illustrative embodiments, the film comprises mPE having a MI of about 0.3 to about 1.0 g/10 min. In one embodiment, the film comprises mPE having a MI of about 0.5 to about 0.8 g/10 min. In another embodiment, the film comprises mPE having a MI of about 0.65 g/10 min. In illustrative embodiments, the film comprises mPE having a density of about 0.910 to about 0.940 g/cm³. In one embodiment, the film comprises mPE having a density of about 0.920 to about 0.930 g/cm³. In another embodiment, the film comprises mPE having a density of about 0.925 g/cm³.

One aspect of the present disclosure is that the mPE includes at least some long chain branches (LCB). This attribute distinguishes a mPE, as described herein, from linear low density polyethylene (LLDPE) described extensively in the art. Specifically, LLDPE has little to no LCB, while the mPE described herein has at least some LCB. The LCB is an aspect of the mPE that contributes to the blended composition providing its recognized properties (shrinking, strength, light scattering, etc.). The effect of branching on the properties of polyethylene depends on the length and the amount of the branches. Short chain branches (SCB), of less than approximately 40 carbon atoms, interfere with the formation of the crystal structure. Short branches mainly influence the mechanical and thermal properties. As the branch length increases, the branches are able to form lamellar structures and the influence on the mechanical and thermal properties is diminished. As used herein, long chain branches are those branches with lengths longer than the average critical entanglement distance of a linear polymer chain.

As used herein, melt index (MI) is a measure of the ease of flow of a polymeric composition. MI is equal to the mass of polymer in grams flowing in 10 minutes through a capillary of specific diameter and length by an applied pressure. ASTM D-1238-00 refers to the standard test method for determining the melt index. MI is an indirect measure of molecular weight; a high melt index typically corresponds to low molecular weight. Furthermore, MI is a measure of the ability of the polymer composition to flow under pressure in its melted form. MI may be considered as inversely proportional to viscosity, but the viscosity is also dependent on the applied force. A melt flow ratio (MFR) is the ratios between two MI values for one polymeric composition at different gravimetric weights and may be used as a measure of the broadness of the molecular weight distribution.

While specific polymer compositions are referred to herein, one of ordinary skill in the art will appreciate that polymers or polymer blends with substantially equivalent physical properties could be substituted; yet remain within the scope and spirit of the present disclosure. In particular, those polymers having substantially equivalent MI and MFR may be particularly suitable.

In an evaluation of the properties of a polyolefinic film, shrink tension and orientation release stress testing may be performed. As a result of the manufacturing process, internal stresses may be locked into the film and these can be released by heating in the form of shrinking. For any given type of film or sheeting, the temperatures which shrinkage will begin are related to processing techniques employed to manufacture the film and also may be related to a phase transition in the polymeric composition. As used herein, orientation release stress is the maximum shrink tension developed by a film in a specified direction throughout its range of shrink temperatures while totally restrained from shrinking. The shrink force is the force per original unit width developed by a film in the specified direction and at a specified temperature in its attempt to shrink while under restraint. The shrink tension is the force per original average cross-sectional area developed by a film in a specified direction and at a specified temperature in its attempt to shrink while under restraint.

In an evaluation of the properties of a polyolefinic film, tensile testing may be performed. Tensile testing involves elongating a specimen and measuring the load carried by the specimen. The dimensions of the specimen and the change in those dimensions upon carrying the load may be used with the load and deflection data to construct a stress-strain curve. Tensile properties can be extracted from the stress-strain curve according to ASTM D 882-00. As used herein, ASTM D 882-00 refers to the standard test method for tensile properties of thin plastic sheeting. Tensile strength is the maximum load divided by the original minimum cross-sectional area of the specimen and differs depending on whether measured in the machine direction or transverse direction. Percent elongation at break may be calculated by dividing the extension at the moment of rupture of the specimen by the initial gage length of the specimen and multiplying by 100.

As used herein, ASTM D 1922-00 refers to the standard test method for propagation tear resistance of plastic film and thin sheeting by pendulum method. The values obtained through the testing methods described by this ASTM standard method are also referred to as Elmendorf values. The Elmendorf values are the force in grams required to propagate tearing across a film or sheeting specimen.

Density values refer to those obtained according to ASTM D 1505-98. This is the standard test method for density of plastics by the density-gradient technique.

In an evaluation of the properties of a polyolefinic film, the specific light-transmitting and wide-angle-scattering properties of the film may be determined according to ASTM D 1003-00. ASTM D 1003 refers to the standard test method for haze and luminous transmittance of transparent plastics. As used herein, haze is the scattering of light by a specimen responsible for the reduction in contrast of objects viewed through it. Haze is measured as the percentage of transmitted light that is scattered so that its direction deviates more than a specified angle from the direction of the incident beam.

In an evaluation of the properties of a polyolefinic film, the relative luminous reflectance factor of a specimen in the mirror direction may be determined according to ASTM D 523-89 (re-approved 1999). ASTM D 523 refers to the standard test method for specular gloss.

In an evaluation of the properties of a polyolefinic film, the linear thermal shrinkage of plastic film and sheeting may be determined according to ASTM D 2732-96. ASTM D 2732 refers to the standard test method for unrestrained linear thermal shrinkage. Unrestrained linear thermal shrinkage, otherwise known as free shrink, refers to the irreversible and rapid reduction in linear dimension in a specified direction occurring in film subjected to elevated temperatures under conditions where nil or negligible restraint to inhibit shrinkage is present. As used herein, it will be expressed as a percentage of the original dimension.

In an evaluation of the properties of a polyolefinic film, the energy that causes the film to fail under specified conditions of impact of a free-falling dart may be determined according to ASTM D 1709-98. ASTM D 1709 refers to the standard test methods for impact resistance of plastic film by the free-falling dart method.

In evaluating the properties of a polyolefin, the average molecular weight and molecular weight distribution may be determined according to ASTM D 4001-93 (2006) which refers to the standard test method for determination of weight-average molecular weight of polymers by light scattering. Another technique which may be used to determine the properties of one or more of the polymer compositions described herein includes temperature rising elution fractionation (TREF). Furthermore, gel permeation chromatography (GPC) can be used alone or coupled with TREF to obtain other properties of a particular polymeric composition.

In illustrative embodiments, the film of the present disclosure is about 0.5 mil to about 7.0 mil in thickness. In another embodiment, the film is about 0.7 mil to about 4.0 mil in thickness. In another embodiment, the film is from about 1.0 mil to about 2.0 mil in thickness. As used herein, the unit mil is used as a thickness equal to one thousandth (10⁻³) of an inch which is approximately equal to 0.0254 millimeters. One aspect of the present disclosure is that the polymeric composition disclosed herein enables the stable manufacture of high performance heat shrinkable films which are thinner than those previously known in the art. The process of making a thinner film is known as down-gauging. While not being limited to any particular theory, the bimodal molecular weight distribution of HDPE stabilizes the film during the manufacturing process and allows thinner films to be reproducibly and controllably produced. Furthermore, the stabilization during manufacturing provides a manufactured film with properties beneficial to heat shrink applications, particularly, an increase in shrink tension.

In illustrative embodiments, a mono-layer shrink film in accordance with the present disclosure has a shrink tension that is 30% greater than a comparably manufactured shrink film using a polymer composition as those known in the art. In one embodiment, a film in accordance with the present disclosure has a shrink tension greater than 3 psi as determined according to ASTM D-2838-00 at about 280 degrees F. (approximately 140 degrees C.).

In illustrative embodiments, the film described herein may be manufactured on a blown film line. In one embodiment, the film is a monolayer film with a homogeneously blended polymeric composition throughout. As used herein, the term homogeneously blended composition means that prior to extruding the polymeric composition, the various polymeric materials incorporated into the film are mechanically blended. One of ordinary skill in the art will understand that a homogeneously blended composition may include microscopic and nanoscopic fluctuations in composition. Furthermore, crystalline and amorphous regions may form within the film and result in compositional fluctuations. These fluctuations are within the scope of what is considered a homogeneously blended composition.

In illustrative embodiments, the film comprises a blend of polyethylene. In one embodiment, the film comprises a blend of HDPE, LDPE, and mPE. In one embodiment, the film comprises about 20-40% (by weight of the composition) HDPE, about 20-40% (by weight of the composition) LDPE, and about 30-50% (by weight of the composition) mPE. In another embodiment, the film comprises about 25-35% (by weight of the composition) HDPE, about 25-35% (by weight of the composition) LDPE, and about 35-45% (by weight of the composition) mPE. In another embodiment, the film comprises about 30% (by weight of the composition) HDPE, about 30% (by weight of the composition) LDPE, and about 40% (by weight of the composition) mPE. In another embodiment, the blend of polyethylene further comprises UV weatherability concentrates, colorants, block, slip, and/or antistatic additives.

In illustrative embodiments, the film is made of a polymer composition having a MI of about 0.25 to about 1.0 g/10 min. In one embodiment, the film is made of a polymer composition that has a MI of about 0.5 to about 0.75 g/10 min. In one embodiment, the film is made of a polymer composition that has a MI of about 0.6 g/10 min. In illustrative embodiments, the film is made of a polymer composition having a density of about 0.915 to about 0.940 g/cm³. In one embodiment, the film is made of a polymer composition having a density of about 0.925 to about 0.930 g/cm³. In one embodiment, the film is made of a polymer composition having a density of about 0.92 g/cm³.

One aspect of the present disclosure is that the film is made with a composition that renders the film capable of scattering light. The scattering reduces the contrast of objects viewed through the film and such haze can be determined according to ASTM D-1003-00. In illustrative embodiments, the film has a haze of greater than about 15 percent. In one embodiment, the film has a haze of greater than about 18 percent. In another embodiment, the film has a haze of greater than about 20 percent. In illustrative embodiments, the specular gloss of at least one side of the film is less than about 40 percent. In one embodiment, the specular gloss of at least one side of the film is less than about 30 percent. In yet another embodiment, the specular gloss of both sides of the film is substantially equivalent. In another embodiment, the specular gloss of both sides of the film is less than about 30 percent.

One aspect of the present disclosure is that the composition of polymer used enables the production of films with surprisingly robust tensile properties. One of ordinary skill in the art would not expect that a polyethylene heat shrinkable film could be manufactured which provide the tensile properties described herein. In particular, the composition described herein enables the gauge of the film to be significantly reduced while still obtaining tensile properties of significantly thicker films.

In illustrative embodiments, the film has tensile strength at break of at least about 5500 psi in the machine direction. In one embodiment, the film has tensile strength at break of at least about 6500 psi in the machine direction. In another embodiment, the film has tensile strength at break of at least about 7500 psi in the machine direction. In illustrative embodiments, the film has tensile strength at break of at least about 4000 psi in the transverse direction. In one embodiment, the film has tensile strength at break of at least about 4500 psi in the transverse direction. In another embodiment, the film has tensile strength at break of at least about 5000 psi in the transverse direction.

In illustrative embodiments, the film has an elongation at break of at least about 650 percent in the machine direction. In one embodiment, the film has an elongation at break of at least about 750 percent in the machine direction. In another embodiment, the film has an elongation at break of at least about 850 percent in the machine direction. In yet another embodiment, the film has an elongation at break of at least about 950 percent in the machine direction. In illustrative embodiments, the film has an elongation at break of at least about 1100 percent in the transverse direction. In one embodiment, the film has an elongation at break of at least about 1200 percent in the transverse direction. In another embodiment, the film has an elongation at break of at least about 1300 percent in the transverse direction.

In illustrative embodiments, the film has a secant modulus (1% strain) of at least about 60000 psi in the machine direction. In one embodiment, the film has a secant modulus (1% strain) of at least about 70000 psi in the machine direction. In another embodiment, the film has a secant modulus (1% strain) of at least about 80000 psi in the machine direction. In illustrative embodiments, the film has a secant modulus (1% strain) of at least about 60000 psi in the transverse direction. In another embodiment, the film has a secant modulus (1% strain) of at least about 65000 psi in the transverse direction.

In illustrative embodiments, the film has a shrink tension of greater than 3 psi at 280 degrees F. In one embodiment, the film has a shrink tension of greater than 3.3 psi at 280 degrees F. In another embodiment, the film has a shrink tension of greater than 3.6 psi at 280 degrees F. In yet another embodiment, the film has a shrink tension of greater than 3.9 psi at 280 degrees F.

One aspect of the present disclosure is that the polyolefinic composition enables the manufacture of films with improved puncture resistance properties. The puncture resistance, as measured by ASTM D-1709 or other well known puncture resistance tests such as ASTM D-5748, is improved over those compositions known in the art. In one embodiment, the puncture resistance according to the ASTM D-1709 dart drop test is at least about 80 g/mil. In another embodiment, the puncture resistance according to the ASTM D-1709 dart drop test is at least about 110 g/mil. In another embodiment, the puncture resistance according to the ASTM D-1709 dart drop test is at least about 140 g/mil.

In illustrative embodiments, a heat-shrinkable monolayer blown film comprises a polymeric composition comprising high density polyethylene, low density polyethylene, and metallocene catalyzed polyethylene, wherein the polymeric composition has a first melt index of about 0.25 to about 1.0 g/10 min and a first density of about 0.915 to about 0.940 g/cm³ and the film has a shrink tension of greater than about 3 psi at about 280 degrees F. In one embodiment, the film has a thickness of about 1 to about 1.5 mils and a haze of greater than about 15%. In another embodiment, the polymeric composition comprises about 30% by weight high density polyethylene, about 30% by weight low density polyethylene, and about 40% by weight metallocene catalyzed density polyethylene. In another embodiment, the film has a tensile strength at break of at least about 7500 psi in the machine direction and at least about 5000 psi in the transverse direction.

In one embodiment, the film has an elongation at break of at least about 800% in the machine direction and at least about 1100% in the transverse direction. In another embodiment, the film has a secant modulus (1% strain) of at least about 80000 psi in the machine direction and at least about 65000 psi in the transverse direction. In yet another embodiment, the high density polyethylene has a second melt index of about 0.15 to about 1.0 g/10 min and a second density of about 0.939 to about 0.960 g/cm³, the low density polyethylene has a third melt index of about 0.3 to about 1.0 g/10 min and a third density of about 0.915 to about 0.930 g/cm³, and the metallocene polyethylene has a second melt index of about 0.3 to about 1.0 g/10 min and a second density of about 0.91 to about 0.94 g/cm³. In one embodiment, the high density polyethylene has a second melt index of about 0.15 to about 1.0 g/10 min and a second density of about 0.939 to about 0.960 g/cm³, the low density polyethylene has a third melt index of about 0.3 to about 1.0 g/10 min and a third density of about 0.915 to about 0.930 g/cm³, and the metallocene polyethylene has a second melt index of about 0.3 to about 1.0 g/10 min and a second density of about 0.91 to about 0.94 g/cm³.

In one embodiment, the film has a tensile strength at break of at least about 7500 psi in the machine direction and at least about 5000 psi in the transverse direction, the film has an elongation at break of at least about 800% in the machine direction and at least about 1100% in the transverse direction, and the film has a secant modulus (1% strain) of at least about 80000 psi in the machine direction and at least about 65000 psi in the transverse direction. In another embodiment, the film has a haze of greater than about 15%, the film has a tensile strength at break of at least about 7500 psi in the machine direction and at least about 5000 psi in the transverse direction, the film has an elongation at break of at least about 800% in the machine direction and at least about 1100% in the transverse direction, the film has a secant modulus (1% strain) of at least about 80000 psi in the machine direction and at least about 65000 psi in the transverse direction, and the film has a thickness of between about 0.7 and about 4 mils. In another embodiment, the polymeric composition comprises about 20-40% by weight high density polyethylene having a second melt index of about 0.15 to about 1.0 g/10 min and a second density of about 0.939 to about 0.960 g/cm³, about 20-40% by weight low density polyethylene having a third melt index of about 0.3 to about 1.0 g/10 min and a third density of about 0.915 to about 0.930 g/cm³, and about 30-50% by weight metallocene catalyzed density polyethylene having a fourth melt index of about 0.3 to about 1.0 g/10 min and a fourth density of about 0.91 to about 0.94 g/cm³, wherein the film has a haze of greater than about 15%, the film has a tensile strength at break of at least about 7500 psi in the machine direction and at least about 5000 psi in the transverse direction, the film has an elongation at break of at least about 800% in the machine direction and at least about 1100% in the transverse direction, and the film has a secant modulus (1% strain) of at least about 80000 psi in the machine direction and at least about 65000 psi in the transverse direction. In another embodiment, the film of claim 1, wherein the film has a thickness of about 0.7 to about 4 mils and a haze of greater than about 18%.

In illustrative embodiments, a monolayer blown film comprises a polymer composition consisting essentially of a metallocene catalyzed polyethylene, a low density polyethylene, and a high density polyethylene, the polymer composition providing shrinking means for causing the film to undergo unrestrained linear thermal shrinkage of at least about 80% in the machine direction in response to heating the film to about 140 degrees C., so that a shrink tension of greater than about 3 psi is generated. In one embodiment, the polymer composition has a first melt index of about 0.25 to about 1.0 g/10 min and a first density of about 0.915 to about 0.940 g/cm³. In another embodiment, the polymer composition further provides a haze of greater than about 15%, a tensile strength at break of at least about 7500 psi in the machine direction and at least about 5000 psi in the transverse direction, an elongation at break of at least about 800% in the machine direction and at least about 1100% in the transverse direction, and a secant modulus (1% strain) of at least about 80000 psi in the machine direction and at least about 65000 psi in the transverse direction. In another embodiment, the film has a thickness of between about 0.7 and about 4 mils. In yet another embodiment, the film further provides a haze of greater than about 15%, a thickness of between about 1 and about 1.5 mils, a tensile strength at break of at least about 7500 psi in the machine direction and at least about 5000 psi in the transverse, an elongation at break of at least about 800% in the machine direction and at least about 1100% in the transverse direction, and a secant modulus (1% strain) of at least about 80000 psi in the machine direction and at least about 65000 psi in the transverse direction.

In one embodiment, the high density polyethylene is bimodal and has a first melt index of about 0.15 to 1.0 g/10 min and a first density of about 0.939 to about 0.960 g/cm³, the low density polyethylene includes substantial long chain branching and short chain branching so that the low density polyethylene has a second melt index of about 0.3 to about 1.0 g/10 min and a second density of about 0.915 to about 0.930 g/cm³, and the metallocene catalyzed polyethylene includes at least some long chain branching so that the metallocene catalyzed polyethylene has a third melt index of about 0.3 to 1.0 g/10 min and a third density of about 0.91 to 0.94 g/cm³. In another embodiment, the high density polyethylene comprises a first population of polyethylene having a first average molecular weight distribution of about 30,000 g/mol and a second population of polyethylene having a second average molecular weight distribution of about 400,000 g/mol. In another embodiment, the high density polyethylene has a first melt index of about 0.15 to 1.0 g/10 min and a first density of about 0.939 to about 0.960 g/cm³, the low density polyethylene includes substantial long chain branching and short chain branching so that the low density polyethylene has a second melt index of about 0.3 to about 1.0 g/10 min and a second density of about 0.915 to about 0.930 g/cm³, and the metallocene catalyzed polyethylene includes at least some long chain branching so that the metallocene catalyzed polyethylene has a third melt index of about 0.3 to 1.0 g/10 min and a third density of about 0.91 to 0.94 g/cm³. In one embodiment, the composition further provides a haze of greater than about 15%, a thickness of between about 0.7 and about 4 mils, a tensile strength at break of at least about 7500 psi in the machine direction and at least about 5000 psi in the transverse direction, an elongation at break of at least about 800% in the machine direction and at least about 1100% in the transverse direction, and a secant modulus (1% strain) of at least about 80000 psi in the machine direction and at least about 65000 psi in the transverse direction.

In illustrative embodiments, a heat-shrinkable monolayer blown film comprises a polymer composition comprising about 20-40% by weight high density polyethylene, about 20-40% by weight low density polyethylene, and about 30-50% by weight metallocene catalyzed polyethylene, wherein the polymer composition is blended to provide means for shrinking to cause the film to hold goods with a shrink tension of greater than 3 psi at 280 degrees F. and to resist breakage from a force of at least about 7500 psi in the machine direction. In one embodiment, the polymer composition has a first melt index of about 0.25 to about 1.0 g/10 min and a first density of about 0.915 to about 0.940 g/cm³. In another embodiment, the polymer composition is blended to further provide means for scattering light to cause at least about 15% of light to be scattered according to ASTM D-1003-00. In another embodiment, the high density polyethylene is bimodal and has a second melt index of about 0.15 to 1.0 g/10 min and a second density of about 0.939 to about 0.960 g/cm³. In yet another embodiment, the low density polyethylene includes substantial long chain branching and short chain branching so that the low density polyethylene has a third melt index of about 0.3 to about 1.0 g/10 min and a third density of about 0.915 to about 0.930 g/cm³. In one embodiment, the metallocene catalyzed polyethylene includes at least some long chain branching so that the metallocene catalyzed polyethylene has a fourth melt index of about 0.3 to 1.0 g/10 min and a fourth density of about 0.91 to 0.94 g/cm³.

In one embodiment, the high density polyethylene is bimodal and has a first melt index of about 0.15 to 1.0 g/10 min and a first density of about 0.939 to about 0.960 g/cm³, the low density polyethylene includes substantial long chain branching and short chain branching so that the low density polyethylene has a second melt index of about 0.3 to about 1.0 g/10 min and a second density of about 0.915 to about 0.930 g/cm³, and the metallocene catalyzed polyethylene includes at least some long chain branching so that the metallocene catalyzed polyethylene has a third melt index of about 0.3 to 1.0 g/10 min and a third density of about 0.91 to 0.94 g/cm³. In another embodiment, the polymer composition is blended to further provide means for elongating to at least about 800% in the machine direction and at least about 1100% in the transverse direction before break.

In another embodiment, the polymer composition is blended to further provide means for scattering light to cause at least about 18% of light to be scattered according to ASTM D-1003-00. In yet another embodiment, the high density polyethylene is bimodal and has a first melt index of about 0.15 to 1.0 g/10 min and a first density of about 0.939 to about 0.960 g/cm³, the low density polyethylene includes substantial long chain branching and short chain branching so that the low density polyethylene has a second melt index of about 0.3 to about 1.0 g/10 min and a second density of about 0.915 to about 0.930 g/cm³, the metallocene catalyzed polyethylene includes at least some long chain branching so that the metallocene catalyzed polyethylene has a third melt index of about 0.3 to 1.0 g/10 min and a third density of about 0.91 to 0.94 g/cm³, the film has a thickness of between about 0.7 and about 4 mils, the film has a tensile strength at break of at least about 7500 psi in the machine direction and at least about 5000 psi in the transverse direction, the film has an elongation at break of at least about 800% in the machine direction and at least about 1100% in the transverse direction, and the film has a secant modulus (1% strain) of at least about 80000 psi in the machine direction and at least about 65000 psi in the transverse direction.

In illustrative embodiments, a method for preparing a blown heat shrinkable film includes blending about 20-40% by weight high density polyethylene, about 20-40% by weight low density polyethylene, and about 30-50% by weight metallocene catalyzed polyethylene, extruding the polymer on a blown line so that the polymer composition creates a microcrystallyine structural orientation that provides a means for shrinking. In one aspect, the composition is such that it can be extruded on a blown line. In another aspect, the composition is such that the blown line maintains stability (the polymeric blown bubble is stable against failures for extended manufacturing periods). In yet another aspect, the composition is such that in a first stage the composition provides sufficient mechanical strength (provided by the polymeric microscrystalline and amorphous structure at the manufacturing temperature) so that a thin film can be formed (e.g. 0.7 to 4 mils). The method further includes cooling the film so that the microcrystalline and/or amorphous structures within the polymer film are locked into the film. These structures provide the film with shrinking means so that the film can irreversibly shrink upon exposure to an elevated temperature during a second stage. Accordingly, at a second stage the composition of the film provides a shrinking means so that upon exposure to heat, the film undergoes shrinkage. The shrinkage is characterizable, as described herein, by the unrestrained linear shrinkage and shrink tension. One skilled in the art will appreciate that after the second stage, in which the film has been shrunk, the film possesses significantly different properties. For example, the film is thicker, it is capable of little additional shrinkage, and its microcrystalline structure possesses less internal stress. Thus, while the composition is maintained, the structural characteristics (specifically microcrystallinity and internal stresses) of that composition are significantly changed by the shrinking step.

Table 1 below depicts comparative test data between films in accordance with embodiments of the present disclosure, and films manufactured in accordance with conventional compositions. Comparative Examples A, B, and C are made with HDPE (40% by weight) and LDPE (60% by weight). Examples 1, 2, and 3 are made with bimodal MWD HDPE (30% by weight), LDPE (30% by weight), and mPE (40% by weight).

TABLE 1

| | Comparative Examples | | | Examples | | |
|---|---|---|---|---|---|---|
| | A | B | C | 1 | 2 | 3 |
| Gauge (mil) | 1.00 | 1.25 | 1.50 | 1.00 | 1.25 | 1.50 |
| Actual Gauge | 0.99 | 1.27 | 1.52 | 0.98 | 1.10 | 1.51 |
| (mil) | | | | | | |
| Tensile-MD | 4434 | 4487 | 4568 | 7678 | 8155 | 8177 |
| (psi) | | | | | | |
| Tensile-TD | 3738 | 4244 | 4144 | 6500 | 5127 | 5237 |
| (psi) | | | | | | |
| Elongation-MD | 490 | 525 | 619 | 811 | 862 | 966 |
| (%) | | | | | | |
| Elongation-TD | 1130 | 1140 | 1180 | 1189 | 1223 | 1301 |
| (%) | | | | | | |
| Secant 1%-MD | 51462 | 52666 | 53865 | 81000 | 86544 | 89345 |
| (psi) | | | | | | |
| Secant 1%-TD | 62285 | 63068 | 63084 | 65270 | 66118 | 67222 |
| (psi) | | | | | | |
| Elmendorf-MD | 77 | 110 | 137 | 159 | 177 | 189 |
| (g) | | | | | | |
| Elmendorf-TD | 458 | 498 | 535 | 750 | 801 | 844 |
| (g) | | | | | | |
| Gloss-I (%) | 33.8 | 34.7 | 35.2 | 26.5 | 27.0 | 27.4 |
| Gloss-II (%) | 31.0 | 32.4 | 33.7 | 27.4 | 28.0 | 28.7 |
| Haze (%) | 19.6 | 19.6 | 20.7 | 20.6 | 21.0 | 22.3 |
| Dart Drop (g) | 46 | 55 | 67 | 144 | 165 | 225 |
| Free Shrink | | | | | | |
| 140 degrees C- | 82 | 80 | 78 | 85 | 82 | 82 |
| MD (%) | | | | | | |
| 140 degrees C- | 19 | 16.5 | 16 | 23 | 20 | 20 |
| TD (%) | | | | | | |
| Shrink Tension | | | | | | |
| 280 degrees F- | 2.56 | 2.67 | 2.88 | 3.3 | 3.4 | 3.8 |
| MD (psi) | | | | | | |
| 280 degrees F- | 0.8 | 1.2 | 1.4 | 2.1 | 2.4 | 2.6 |
| TD (psi) | | | | | | |

One aspect of the present disclosure is that the composition of polymer used enables the production of films with remarkable shrink properties. One of ordinary skill in the art would not expect that a polyethylene heat shrinkable film could be manufactured which provide the shrink properties described herein. In particular, the composition described herein enables the gauge of the film to be significantly reduced while still obtaining shrink properties of significantly thicker films. The surprising shrink properties are particularly noticeable in that the films of the present disclosure exhibit shrink tensions 30% greater than those films known in the art, as shown with respect to the comparative examples. Shrink tension is effectively a gauge normalized measure of shrink force; accordingly, the shrink tension between different gauges of film can be compared.

Another aspect of the film is the concurrent improvement of the tensile strength, elongation at break, and the secant modulus over the prior art films. Specifically, the tensile strength in the machine direction is about 80% greater than those films known in the art. Surprisingly, this improvement in strength was concurrent with an improvement in flexibility; specifically, the elongation at break is about 60% greater than a prior art film. Additionally, the secant modulus in the machine direction is about 60% greater than a prior art film.

Based on tensile strength, elongation at break, and secant modulus, one could predict a stress strain curve indicating very high film performance. One of ordinary skill in the art will appreciate that the energy under the stress-strain curve is significantly higher than the energy under the stress-strain curve of the comparably prepared prior art composition (Comparative Examples A, B, and C). While it is expected that the shape of the stress-strain curve could be modified to provide enhancements with respect to some film characteristics while diminishing others, this type of modification would lead to little, if any, increase in the area under the stress-strain curve. It is unexpected that the shape of the stress-strain curve could be altered so dramatically so that a dramatic increase in energy under the curve is achieved. While unexpected, Examples 1, 2, and 3 exhibit such a dramatic increase in energy under the curve. In this respect, a synergistic relationship has been determined between the specific HDPE, LDPE, and mPE described herein. This synergism results in unexpected high performance film characteristics.

1. A heat-shrinkable monolayer blown film comprising
a polymeric composition comprising high density polyethylene, low density polyethylene, and metallocene catalyzed polyethylene, wherein the polymeric composition has a first melt index of about 0.25 to about 1.0 g/10 min as determined according to ASTM D 1238-00 and a first density of about 0.915 to about 0.940 g/cm³ as determined according to ASTM D 1505-98 and the film has a shrink tension of greater than about 3 psi at about 280 degrees F. as determined according to ASTM D-2838-95.

2. The film of claim 1, wherein the film has a thickness of about 1 to about 1.5 mils and a haze of greater than about 15% established according to ASTMD-1003-00.

3. The film of claim 2, wherein the polymeric composition comprises about 30% by weight high density polyethylene, about 30% by weight low density polyethylene, and about 40% by weight metallocene catalyzed density polyethylene.

4. The film of claim 2, wherein the film has a tensile strength at break of at least about 7500 psi in the machine direction and at least about 5000 psi in the transverse direction established according to ASTM D-882-00.

5. The film of claim 2, wherein the film has an elongation at break of at least about 800% in the machine direction and at least about 1100% in the transverse direction established according to ASTM D-882-00.

6. The film of claim 2, wherein the film has a secant modulus (1% strain) of at least about 80000 psi in the machine direction and at least about 65000 psi in the transverse direction established according to ASTM D-882-00.

7. The film of claim 2, wherein
the high density polyethylene has a second melt index of about 0.15 to about 1.0 g/10 min and a second density of about 0.939 to about 0.960 g/cm³,
the low density polyethylene has a third melt index of about 0.3 to about 1.0 g/10 min and a third density of about 0.915 to about 0.930 g/cm³, and
the metallocene polyethylene has a second melt index of about 0.3 to about 1.0 g/10 min and a second density of about 0.91 to about 0.94 g/cm³.

8. The film of claim 3, wherein
the high density polyethylene has a second melt index of about 0.15 to about 1.0 g/10 min and a second density of about 0.939 to about 0.960 g/cm³,
the low density polyethylene has a third melt index of about 0.3 to about 1.0 g/10 min and a third density of about 0.915 to about 0.930 g/cm³, and
the metallocene polyethylene has a second melt index of about 0.3 to about 1.0 g/10 min and a second density of about 0.91 to about 0.94 g/cm³.

9. The film of claim 3, wherein
the film has a tensile strength at break of at least about 7500 psi in the machine direction and at least about 5000 psi in the transverse direction established according to ASTM D-882-00,
the film has an elongation at break of at least about 800% in the machine direction and at least about 1100% in the transverse direction established according to ASTM D-882-00, and
the film has a secant modulus (1% strain) of at least about 80000 psi in the machine direction and at least about 65000 psi in the transverse direction established according to ASTM D-882-00.

10. The film of claim 1, wherein
the film has a haze of greater than about 15% established according to ASTM D-1003-00,
the film has a tensile strength at break of at least about 7500 psi in the machine direction and at least about 5000 psi in the transverse direction established according to ASTM D-882-00,
the film has an elongation at break of at least about 800% in the machine direction and at least about 1100% in the transverse direction established according to ASTM D-882-00,
the film has a secant modulus (1% strain) of at least about 80000 psi in the machine direction and at least about 65000 psi in the transverse direction established according to ASTM D-882-00, and
the film has a thickness of between about 0.7 and about 4 mils.

11. The film of claim 1, the polymeric composition comprising
about 20-40% by weight high density polyethylene having a second melt index of about 0.15 to about 1.0 g/10 min and a second density of about 0.939 to about 0.960 g/cm³,
about 20-40% by weight low density polyethylene having a third melt index of about 0.3 to about 1.0 g/10 min and a third density of about 0.915 to about 0.930 g/cm³, and
about 30-50% by weight metallocene catalyzed density polyethylene having a fourth melt index of about 0.3 to about 1.0 g/10 min and a fourth density of about 0.91 to about 0.94 g/cm³, wherein
the film has a haze of greater than about 15% established according to ASTM D-1003-00,
the film has a tensile strength at break of at least about 7500 psi in the machine direction and at least about 5000 psi in the transverse direction established according to ASTM D-882-00,
the film has an elongation at break of at least about 800% in the machine direction and at least about 1100% in the transverse direction established according to ASTM D-882-00, and
the film has a secant modulus (1% strain) of at least about 80000 psi in the machine direction and at least about 65000 psi in the transverse direction established according to ASTM D-882-00.

12. The film of claim 1, wherein the film has a thickness of about 0.7 to about 4 mils and a haze of greater than about 18% established according to ASTM D-1003-00.

13. A monolayer blown film comprising
a polymer composition consisting essentially of a metallocene catalyzed polyethylene, a low density polyethylene, and a high density polyethylene, the polymer composition providing shrinking means for causing the film to undergo unrestrained linear thermal shrinkage of at least about 80% in the machine direction in response to heating the film to about 140 degrees C., so that a shrink tension of greater than about 3 psi is generated.

14. The film of claim 13, wherein the polymer composition has a first melt index of about 0.25 to about 1.0 g/10 min as determined according to ASTM D 1238-00 and a first density of about 0.915 to about 0.940 g/cm³ as determined according to ASTM D 1505-98.

15. The film of claim 14, wherein the polymer composition further provides
a haze of greater than about 15% established according to ASTM D-1003-00,
a tensile strength at break of at least about 7500 psi in the machine direction and at least about 5000 psi in the transverse direction established according to ASTM D-882-00,
an elongation at break of at least about 800% in the machine direction and at least about 1100% in the transverse direction established according to ASTM D-882-00, and
a secant modulus (1% strain) of at least about 80000 psi in the machine direction and at least about 65000 psi in the transverse direction established according to ASTM D-882-00.

16. The film of claim 15, wherein the film has a thickness of between about 0.7 and about 4 mils.

17. The film of claim 13, wherein the film further provides
a haze of greater than about 15% established according to ASTM D-1003-00,
a thickness of between about 1 and about 1.5 mils,
a tensile strength at break of at least about 7500 psi in the machine direction and at least about 5000 psi in the transverse direction established according to ASTM D-882-00,
an elongation at break of at least about 800% in the machine direction and at least about 1100% in the transverse direction established according to ASTM D-882-00, and
a secant modulus (1% strain) of at least about 80000 psi in the machine direction and at least about 65000 psi in the transverse direction established according to ASTM D-882-00.

18. The film of claim 17, wherein
the high density polyethylene is bimodal and has a first melt index of about 0.15 to 1.0 g/10 min and a first density of about 0.939 to about 0.960 g/cm³,
the low density polyethylene includes substantial long chain branching and short chain branching so that the low density polyethylene has a second melt index of about 0.3 to about 1.0 g/10 min and a second density of about 0.915 to about 0.930 g/cm³, and
the metallocene catalyzed polyethylene includes at least some long chain branching so that the metallocene catalyzed polyethylene has a third melt index of about 0.3 to 1.0 g/10 min and a third density of about 0.91 to 0.94 g/cm³.

19. The film of claim 13, wherein the high density polyethylene comprises a first population of polyethylene having a first average molecular weight distribution of about 30,000 g/mol and a second population of polyethylene having a second average molecular weight distribution of about 400,000 g/mol.

20. The film of claim 19, wherein
the high density polyethylene has a first melt index of about 0.15 to 1.0 g/10 min and a first density of about 0.939 to about 0.960 g/cm³,
the low density polyethylene includes substantial long chain branching and short chain branching so that the low density polyethylene has a second melt index of about 0.3 to about 1.0 g/10 min and a second density of about 0.915 to about 0.930 g/cm³, and
the metallocene catalyzed polyethylene includes at least some long chain branching so that the metallocene catalyzed polyethylene has a third melt index of about 0.3 to 1.0 g/10 min and a third density of about 0.91 to 0.94 g/cm³.

21. The film of claim 19, wherein the composition further provides
a haze of greater than about 15% established according to ASTM D-1003-00,
a thickness of between about 0.7 and about 4 mils,
a tensile strength at break of at least about 7500 psi in the machine direction and at least about 5000 psi in the transverse direction established according to ASTM D-882-00,
an elongation at break of at least about 800% in the machine direction and at least about 1100% in the transverse direction established according to ASTM D-882-00, and
a secant modulus (1% strain) of at least about 80000 psi in the machine direction and at least about 65000 psi in the transverse direction established according to ASTM D-882-00.

22. A heat-shrinkable monolayer blown film comprising
a polymer composition comprising about 20-40% by weight high density polyethylene, about 20-40% by weight low density polyethylene, and about 30-50% by weight metallocene catalyzed polyethylene, wherein the polymer composition is blended to provide means for shrinking to cause the film to hold goods with a shrink tension of greater than 3 psi at 280 degrees F. as determined according to ASTM D-2838-95 and to resist breakage from a force of at least about 7500 psi in the machine direction as determined according to ASTM D-882-00.

23. The film of claim 22, wherein the polymer composition has a first melt index of about 0.25 to about 1.0 g/10 min as determined according to ASTM D 1238-00 and a first density of about 0.915 to about 0.940 g/cm³ as determined according to ASTM D 1505-98.

24. The film of claim 23, wherein the polymer composition is blended to further provide means for scattering light to cause at least about 15% of light to be scattered according to ASTM D-1003-00.

25. The film of claim 24, wherein the high density polyethylene is bimodal and has a second melt index of about 0.15 to 1.0 g/10 min and a second density of about 0.939 to about 0.960 g/cm³.

26. The film of claim 24, wherein the low density polyethylene includes substantial long chain branching and short chain branching so that the low density polyethylene has a third melt index of about 0.3 to about 1.0 g/10 min and a third density of about 0.915 to about 0.930 g/cm³.

27. The film of claim 24, wherein the metallocene catalyzed polyethylene includes at least some long chain branching so that the metallocene catalyzed polyethylene has a fourth melt index of about 0.3 to 1.0 g/10 min and a fourth density of about 0.91 to 0.94 g/cm³.

28. The film of claim 24, wherein
the high density polyethylene is bimodal and has a first melt index of about 0.15 to 1.0 g/10 min and a first density of about 0.939 to about 0.960 g/cm³,
the low density polyethylene includes substantial long chain branching and short chain branching so that the low density polyethylene has a second melt index of about 0.3 to about 1.0 g/10 min and a second density of about 0.915 to about 0.930 g/cm³, and
the metallocene catalyzed polyethylene includes at least some long chain branching so that the metallocene catalyzed polyethylene has a third melt index of about 0.3 to 1.0 g/10 min and a third density of about 0.91 to 0.94 g/cm³.

29. The film of claim 28, wherein the polymer composition is blended to further provide means for elongating to at least about 800% in the machine direction and at least about 1100% in the transverse direction before break as determined according to ASTM D-882-00.

30. The film of claim 22, wherein the polymer composition is blended to further provide means for scattering light to cause at least about 18% of light to be scattered according to ASTM D-1003-00.

31. The film of claim 30, wherein
the high density polyethylene is bimodal and has a first melt index of about 0.15 to 1.0 g/10 min and a first density of about 0.939 to about 0.960 g/cm³,
the low density polyethylene includes substantial long chain branching and short chain branching so that the low density polyethylene has a second melt index of about 0.3 to about 1.0 g/10 min and a second density of about 0.915 to about 0.930 g/cm³,
the metallocene catalyzed polyethylene includes at least some long chain branching so that the metallocene catalyzed polyethylene has a third melt index of about 0.3 to 1.0 g/10 min and a third density of about 0.91 to 0.94 g/cm³,
the film has a thickness of between about 0.7 and about 4 mils,
the film has a tensile strength at break of at least about 7500 psi in the machine direction and at least about 5000 psi in the transverse direction established according to ASTM D-882-00,
the film has an elongation at break of at least about 800% in the machine direction and at least about 1100% in the transverse direction established according to ASTM D-882-00, and
the film has a secant modulus (1% strain) of at least about 80000 psi in the machine direction and at least about 65000 psi in the transverse direction established according to ASTM D-882-00.
